(19) United States
(12) Patent Application Publication
(10) Pub. No.: US 2016/0223832 A1
(43) Pub. Date: Aug. 4, 2016

(54) EYEWEAR DEVICE

(71) Applicant: James P. Hall, Cherry Hill, NJ (US)

(72) Inventor: James P. Hall, Cherry Hill, NJ (US)

(21) Appl. No.: 15/011,275

(22) Filed: Jan. 29, 2016

Related U.S. Application Data
(60) Provisional application No. 62/110,437, filed on Jan. 30, 2015.

(51) Int. Cl. G02C 5/00; G02C 13/00; G02C 11/00; G02C 5/16; G02B 27/22

(52) U.S. Cl. CPC G02C 5/008; G02C 5/16; G02B 27/2228; G02C 11/10; G02C 13/001; G02C 2200/14; G02C 2200/12

(57) ABSTRACT

An eyewear device for aiding vision or protecting eyes of a user is provided. The eyewear device comprises a frame having a first end, a second end, and a centerline with the frame constructed from a plurality of layered flexible, bistable spring bands. A first lens opening is formed completely through the frame between the first end and the centerline of the frame and a second lens opening is formed completely through the frame between the second end and the centerline of the frame. A first lens and a second lens are positioned in the first lens opening and the second lens opening, respectively. The frame is straightenable by tensioning the spring bands. Upon moving the first end in a general direction toward the second end, the spring bands spring into a curve thereby capable of releasably securing the frame to the face of the user.

### CLAIM OF PRIORITY

This patent application claims priority under 35 USC 119 (e) (1) from U.S. Provisional Patent Application Ser. No. 62/110,437 filed Jan. 30, 2015, of common inventorship herewith entitled, “Snap N See Glasses,” which is incorporated herein by reference as though the same were set forth in its entirety.

### FIELD OF THE INVENTION

The present invention pertains to the field of eye corrective and protective lenses, and more specifically to the field of wearable eyeglasses.

### BACKGROUND OF THE INVENTION

Every day, an astonishing number of Americans depend on corrective and protective lenses to help them see well enough to complete their daily tasks. To improve their vision, these consumers are prescribed corrective eyewear, from practically invisible contact lenses to external eyeglasses. Many sight challenged individuals are very sensitive to bright sunlight, and don darkened, light filtering sunglasses as a protective measure. Whether as a means of blocking the sun or to express a fashion statement, sunglasses serve both a practical and aesthetic purpose for visually impaired wearers and those wearers with perfect sight.

While prescription glasses are necessary and sunglasses are convenient, using these corrective and protective lenses does have a drawback. Keeping up with a pair of eyeglasses or shades is quite a challenge on hectic and busy days. Most bespectacled consumers remove their eyewear several times during the day, whether it is because they only need them for reading or they simply desire to rest their eyes. Setting the glasses aside, it is very easy for these lens wearers to be distracted by sudden demands of the job and home and forget where they have set their glasses. As a result, a frustrating and time consuming search ensues to locate their vision enhancers. Placing glasses on a table top, desk or similar surface puts them in a precarious position to be inadvertently knocked to the floor, resulting in scratched or broken lenses. Sunglass aficionados face similar obstacles with keeping up with their shaded eyewear. As repeated trips in and out of doors necessitate the frequent removal and replacing of shades, sunglass wearers often find they have misplaced or left behind their sunglasses.

The prior art has put forth several designs for wearable eyeglasses. Among these are:

US Patent 2014/0063440 to Tracey Butler describes eyeglasses that are wearable in alternate forms. The eyeglasses include an eyepiece having a pair of lenses that is positionable around a wearer's eyes by an attachment assembly which also is adjustable to secure the lenses to the wearer's wrist. The formation of the attachment assembly varies according to specific needs. In one embodiment, the attachment assembly comprises temples having temple tips. The temples are deformable to serve alternating purposes of placing the eyepiece in front of the eyes or securing the eye piece around the wearer's wrist or other body parts. The eyepiece includes a bendable bridge that connects the two lenses. This bendable bridge facilitates the transition of the eyepiece from one position to the other. The eyeglasses are suitable for individuals that wear eyeglasses periodically and particularly in outdoor settings.

US Patent 2013/0321759 to Catherine M. Allen describes an article of eyewear that is wearable on the wrist and capable of rapid removal and return as needed. The article of eyewear includes an elongated bi stable ribbon spring member. Two lenses are disposed along a side edge of the elongated bi stable ribbon spring member in a spaced apart relationship with each other along the side edge. A flexible covering encases the elongated bi stable spring and the two lenses. An arcuate shape portion is defined between the two lenses.

U.S. Pat. No. 7,131,167 to Louis Stagnaro describes a neck leash device for retaining eyewear while the wearer is in the water. The device has a leash portion which contains a float for easy location of the eyewear if lost, a wrist band for secondary safety if the leash comes over the wearer's head, a quick release on the wrist band if the leash becomes tangled with the wearer, a pocket to hold small valuables, and a clamp that attaches to each end of said leash at the strap and each arm of the eyewear. A preferred embodiment includes a leash portion made of an elastic cord and a float connected at the bottom of the two straps connecting to the arms of the eyewear and the single extending leash. The leash extends beyond the float approximately four feet and ends in a neoprene wrist band with interlocking hook and loop connector material, a pocket to hold valuables, and a break free device.

None of these prior art references describe the present invention.

### SUMMARY OF THE INVENTION

It is an object of the present invention to provide a line of reading, prescription, and sunglass eyewear specifically constructed to be worn on an individual's wrist as a bracelet when nonfunctioning as eyeglasses on an individual's face.

The present invention is an eyewear device for aiding vision or protecting eyes of a user. The eyes are positioned in a face. The eyewear device comprises a frame having a first end, a second end, and a centerline equally positioned between the first end and the second end with the frame constructed from a plurality of layered flexible, bistable spring bands. A first lens opening is formed completely through the frame between the first end and the centerline of the frame and a second lens opening is formed completely through the frame between the second end and the centerline of the frame. A first lens is positioned in the first lens opening and a second lens is positioned in the second lens opening. The frame is straightenable by tensioning the spring bands. Upon moving the first end in a general direction toward the second end, the spring bands of the frame spring into a curve thereby capable of releasably securing the frame to the face of the user.

In addition, the present invention includes a method for aiding vision or protecting eyes of a user. The eyes are positioned in a face. The method comprises providing a frame having a first end, a second end, and a centerline equally positioned between the first end and the second end, constructing the frame from a plurality of layered flexible, bistable spring bands, forming a first lens opening completely through the frame between the first end and the centerline of the frame, forming a second lens opening completely through the frame between the second end and the centerline of the frame, positioning a first lens in the first lens opening, positioning a second lens in the second lens opening, straightening the frame by tensioning the spring bands, moving the first end in a general direction toward the second end, and springing the spring bands of the frame into a curve thereby capable of releasably securing the frame to the face of the user.

The present invention further includes an eyewear device for aiding vision or protecting eyes of a user. The eyes are positioned in a face. The eyewear device comprises a frame having a first end, a second end, and a centerline equally positioned between the first end and the second end with the frame constructed from a plurality of layered flexible, bistable spring bands. A cover envelops the spring bands. A first lens opening is formed completely through the frame between the first end and the centerline of the frame and nearingly adjacent the centerline of the frame and a second lens opening is formed completely through the frame between the second end and the centerline of the frame and nearingly adjacent the centerline of the frame. A first lens is positioned in the first lens opening and a second lens positioned in the second lens opening. A first ear cutout is formed in the frame adjacent the first end of the frame and a second ear cutout is formed in the frame adjacent the second end of the frame. A nose cutout is formed in the frame between the first lens opening and the second lens opening at the centerline of the frame. The frame is straightenable by tensioning the spring bands. Upon moving the first end in a general direction toward the second end, the spring bands of the frame spring into a curve thereby capable of releasably securing the frame to the face of the user.

### BRIEF DESCRIPTION OF THE DRAWINGS

FIG. 1 is a perspective view illustrating the eyewear device of the present invention being worn on an individual's wrist.

FIG. 2 is a perspective view illustrating the eyewear device of the present invention showing the present invention in an unattached elongated position that measures approximately fifteen inches in length.

FIG. 3 shows numerous perspective views of the eyewear device of the present invention in attached circular positions and in various patterns and colors.

FIG. 4 is an elevational side view illustrating the eyewear device of the present invention.

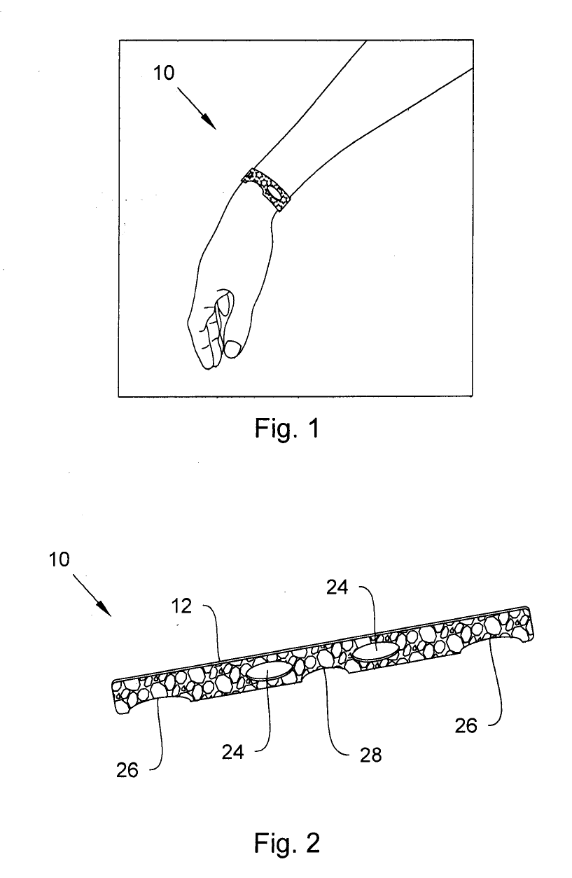

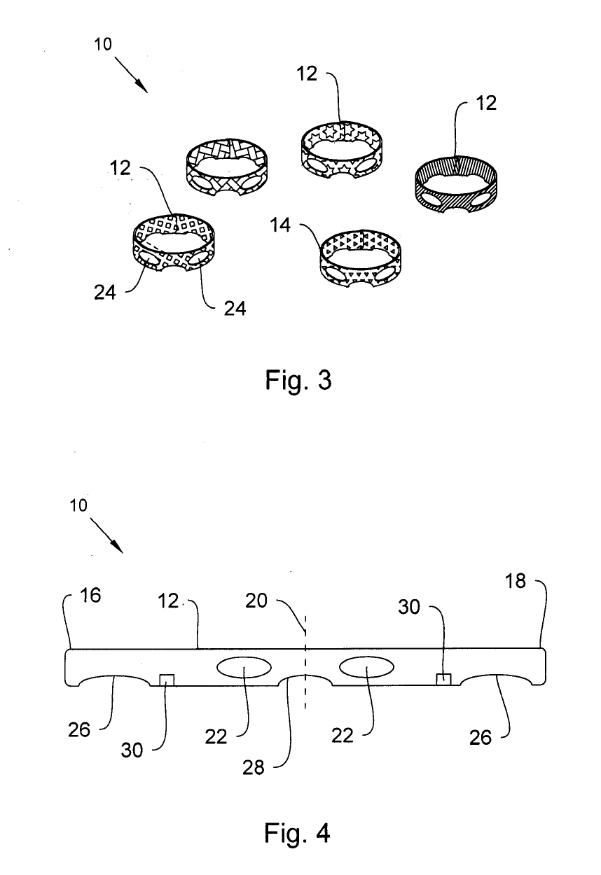

### DETAILED DESCRIPTION OF THE INVENTION

The present invention, hereinafter referred to as an Eyewear Device, indicated generally at 10, is a line of reading, prescription, and sunglass eyewear specifically constructed to be worn on an individual's wrist as a bracelet when nonfunctioning and as eyeglasses on the individual's face when functioning. The Eyewear Device 10 provides a practical solution to the problems lens wearers face with keeping track of their glasses. Using the Eyewear Device 10, wearers no longer juggle externals such as cases, chains, or other secondary apparatuses to keep track of their glasses. Virtually indestructible, the Eyewear Device 10 of the present invention is elongated and rectangular in shape and is constructed in a manner similar to a slap or snap bracelet.

The Eyewear Device 10 of the present invention includes a frame 12 consisting of layered flexible, stainless steel bistable spring bands that are sealed within a fabric or plastic cover 14. The frame 12 can be straightened out, making tension within the springy metal bands. When straightened, the frame 12 has a first end 16 and a second end 18 with a centerline 20 evenly spaced between the first end 16 and the second end 18 of the frame 12. The straightened frame 12 is then deformed by moving the first end 16 in a general direction toward the second end 18 causing the frame 12 to spring back into a curve that wraps around the head, releasably securing the frame 12 to the wearer.

In addition, the frame 12 of the Eyewear Device 10 of the present invention has a pair of apertures 22 formed completely through the frame 12 on each side of a centerline 20 for receiving appropriate lenses 24. In a preferred embodiment, each aperture 22 is substantially oval in shape and has dimensions of approximately one (1″) inch wide and approximately one-half (½″) inch tall. Preferably, the lenses 24 are shaped similar to the apertures 22, mounted in the apertures 22 by press-fit, adhesive, or other mechanical means, and are at least somewhat flexible to bend with the frame 12 when the frame 12 curves about the wearer's head.

Furthermore, the frame 12 of the Eyewear Device 10 of the present invention preferably has small ear cutouts 26 for both ears at the first end 16 and the second end 18 of the frame 12 and a nose bridge cutout 28 positioned between the apertures 22 at the centerline 20 of the frame 12. In a preferred embodiment, the ear cutouts 26 for the ears are each approximately one and one-half (½″) inches in width and approximately one-half (½″) inch in depth. In a preferred embodiment, the nose bridge cutout 28 is approximately one (1″) inch tapering to approximately one-half (½″) inch. The subtle nature of these accoutrements ensures the integrity of the flexible stainless steel spring is unaltered and the present invention is able to keep its bistable structure.

Each Eyewear Device 10 of the present invention preferably measures approximately fifteen to sixteen inches in length when straightened and is sized to comfortably contour around a face of any wearer. The Eyewear Device 10 of the present invention is available for prescription lenses; standard reading magnifiers, and nonprescription and prescription sunglasses. The Eyewear Device 10 of the present invention is produced in a wide variety of colors and patterns to appeal to individual tastes. In addition, the Eyewear Device 10 is available in whimsical and personalized styles containing sports team logos and mascots, festive cartoon characters and corporate emblems.

In an embodiment, 3-D glass lenses can be incorporated into the Eyewear Device 10 of the present invention. This permits users at amusement parks and theme parks to utilize the Eyewear Device 10 of the present invention so that a user could wear the Eyewear Device 10 in conjunction with a ride that utilizes 3-D technology.

In an embodiment, a small pocket 30 molded in the plastic or rubber fabric on one or both sides of the frame 12 of the Eyewear

Device 10 of the present invention is configured to house an RFID (Radio Frequency Identification) chip. In a preferred embodiment, the pocket 30 is approximately one-half (½″) inch by one-half (½″) inch although could be as large as approximately one (1″) inch by one (1″) inch. The RFID chip can associate a particular pair of Eyewear Device 10 with an electronic serial number. Amusement parks and other businesses requiring guests and associates to identify themselves with “smart badges” can utilize the Eyewear Device 10 as their identification band or badge. This allows the Eyewear Device 10 to double as glasses (sunglasses, reading glasses, prescription glasses or 3-D glasses) and also function as an RFID identification. The RFID technology herein contemplates is not limited any specific semiconductor chip technology.

The Eyewear Device 10 of the present invention provides corrective lens, reading, and sunglass wearers with a convenient and effective means of keeping track of their eyewear. Eliminating fruitless searches for a pair of glasses or shades during busy days, the Eyewear Device 10 of the present invention permits eyeglass wearers to keep their glasses on their person at all times. Wearers of the Eyewear Device 10 avoid leaving behind expensive sunglasses or scratching and breaking costly prescription lenses. The present invention's snap bracelet configuration allows the frame 12 to be swiftly wrapped around one's wrist and be retrieved in seconds when needed. The soft padded frames 12 of Eyewear Device 10 provide the wearer with an extremely comfortable wear for extended periods. Durable and portable, attractive and practical, the Eyewear Device 10 will withstand many years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. An eyewear device for aiding vision or protecting eyes of a user, the eyes positioned in a face, the eyewear device comprising:
a frame having a first end, a second end, and a centerline equally positioned between the first end and the second end, the frame constructed from a plurality of layered flexible, bistable spring bands;
a first lens opening formed completely through the frame between the first end and the centerline of the frame;
a second lens opening formed completely through the frame between the second end and the centerline of the frame;
a first lens positioned in the first lens opening; and
a second lens positioned in the second lens opening;
wherein the frame is straightenable by tensioning the spring bands; and
wherein upon moving the first end in a general direction toward the second end, the spring bands of the frame spring into a curve thereby capable of releasably securing the frame to the face of the user.

2. The eyewear device of claim 1 wherein the spring bands are constructed from a stainless steel material.

3. The eyewear device of claim 1 and further comprising:
a cover enveloping the spring bands.

4. The eyewear device of claim 3 wherein the cover is constructed from a material selected from the group consisting of fabric and plastic.

5. The eyewear device of claim 4 wherein the material of the cover has a variety of colors and patterns.

6. The eyewear device of claim 1 wherein the first lens opening and the second lens opening are positioned nearingly adjacent the centerline of the frame.

7. The eyewear device of claim 1 wherein the first lens and the second lens have flexibility to conform to the bend of the frame.

8. The eyewear device of claim 1 and further comprising:
a first ear cutout formed in the frame adjacent the first end of the frame; and
a second ear cutout formed in the frame adjacent the second end of the frame.

9. The eyewear device of claim 1 and further comprising:
a nose cutout formed in the frame between the first lens opening and the second lens opening at the centerline of the frame.

10. The eyewear device of claim 1 wherein the first lens and the second lens are selected from the group consisting of prescription lenses, standard reading magnifiers, and nonprescription and prescription sunglasses.

11. The eyewear device of claim 1 wherein the first lens and the second lens are 3-D glass lenses.

12. The eyewear device of claim 1 and further comprising:
at least one pocket formed in the frame for receiving an RFID (Radio Frequency Identification) chip;
wherein the RFID chip associates a particular pair of an eyewear device with an electronic serial number.

13. A method for aiding vision or protecting eyes of a user, the eyes positioned in a face, the method comprising:
providing a frame having a first end, a second end, and a centerline equally positioned between the first end and the second end;
constructing the frame from a plurality of layered flexible, bistable spring bands;
forming a first lens opening completely through the frame between the first end and the centerline of the frame;
forming a second lens opening completely through the frame between the second end and the centerline of the frame;
positioning a first lens in the first lens opening;
positioning a second lens in the second lens opening;
straightening the frame by tensioning the spring bands;
moving the first end in a general direction toward the second end; and
springing the spring bands of the frame into a curve thereby capable of releasably securing the frame to the face of the user.

14. An eyewear device for aiding vision or protecting eyes of a user, the eyes positioned in a face, the eyewear device comprising:
a frame having a first end, a second end, and a centerline equally positioned between the first end and the second end, the frame constructed from a plurality of layered flexible, bistable spring bands;
a cover enveloping the spring bands;
a first lens opening formed completely through the frame between the first end and the centerline of the frame and nearingly adjacent the centerline of the frame;
a second lens opening formed completely through the frame between the second end and the centerline of the frame and nearingly adjacent the centerline of the frame;
a first lens positioned in the first lens opening;
a second lens positioned in the second lens opening;
a first ear cutout formed in the frame adjacent the first end of the frame;
a second ear cutout formed in the frame adjacent the second end of the frame; and
a nose cutout formed in the frame between the first lens opening and the second lens opening at the centerline of the frame;
wherein the frame is straightenable by tensioning the spring bands; and
wherein upon moving the first end in a general direction toward the second end, the spring bands of the frame spring into a curve thereby capable of releasably securing the frame to the face of the user.

15. The eyewear device of claim 14 wherein the spring bands are constructed from stainless steel.

16. The eyewear device of claim 14 wherein the cover is constructed from a material selected from the group consisting of fabric and plastic.

17. The eyewear device of claim 14 wherein the first lens and the second lens have flexibility to conform to the bend of the frame.

18. The eyewear device of claim 14 wherein the first lens and the second lens are selected from the group consisting of prescription lenses, standard reading magnifiers, and nonprescription and prescription sunglasses.

19. The eyewear device of claim 14 wherein the first lens and the second lens are 3-D glass lenses.

20. The eyewear device of claim 14 and further comprising:
at least one pocket formed in the frame for receiving an RFID (Radio Frequency Identification) chip;
wherein the RFID chip associates a particular pair of an eyewear device with an electronic serial number.
